(19) United States
(12) Patent Application Publication
(10) Pub. No.: US 2026/0009440 A1
(43) Pub. Date: Jan. 8, 2026

(54) BRAKE ACTUATOR AND METHOD FOR OPERATING A BRAKE ACTUATOR

(71) Applicant: ZF Active Safety GmbH, Koblenz (DE)

(72) Inventors: Roman Bechmann, Koblenz (DE); Marcus Janson, Koblenz (DE)

(21) Appl. No.: 19/257,632

(22) Filed: Jul. 2, 2025

(30) Foreign Application Priority Data
Jul. 4, 2024 (DE) 102024118971.1

(51) Int. Cl. F16D 65/18; F16D 121/24; F16D 125/52; F16D 127/06

(52) U.S. Cl. CPC F16D 65/18; F16D 2121/24; F16D 2125/52; F16D 2127/06

(57) ABSTRACT

A brake actuator for an electromechanical vehicle brake has a locking assembly (40) for selectively rotationally blocking an output shaft (42) of an electric motor to form a parking brake function. The locking assembly (40) has a locking pawl (44) which is pivotable between a locked position and a release position and a drive (46) for pivoting the locking pawl (44), which drive is coupled in terms of drive via a worm gear (54) to the locking pawl (44). After pivoting the locking pawl (44) into the locked position, wherein the locking pawl (44) engages in a tooth intermediate space (65) of a drive pinion (52), which is coupled to the output shaft (42) of the electric motor (28), the electromechanical vehicle brake can be retightened when it cools down, wherein the drive pinion (52) rotates in a direction increasing the brake force and the locking pawl (44) is released from the tooth intermediate space (65) counter to a spring force and after the rotation of the drive pinion (52) is latched by the spring force in an adjacent tooth intermediate space (65).

### TECHNICAL FIELD

The invention relates to a brake actuator for an electromechanical vehicle brake and a method for operating a brake actuator.

### BACKGROUND

Brake actuators are used in vehicle brakes in order to apply a brake pad to a brake rotor. To this end, the brake actuator generally has an electric motor which is coupled in terms of drive via a gear unit and a spindle drive to an actuating carriage which can be selectively moved between a retracted position and an extended position in order to apply the brake pad to the brake rotor. In particular, an axial feed force is transferred from the actuating carriage to the brake pad in order to apply the brake pad to the brake rotor.

If the vehicle brake is used as a service brake, it is configured to be self-releasing. If the electromechanical vehicle brake is also intended to function as a parking brake, in addition to its function as a service brake, generally a locking mechanism which prevents an automatic release of the vehicle brake is provided for implementing a parking brake function.

### SUMMARY

It is an object of the present invention to provide a brake actuator by which the functionality of an electromechanical vehicle brake can be even further increased.

This object is achieved by a brake actuator for an electromechanical vehicle brake, wherein the brake actuator has an electric motor for actuating the vehicle brake and a locking assembly for selectively rotationally blocking an output shaft of the electric motor to form a parking brake function, and wherein the locking assembly comprises a locking pawl which is pivotable between a locked position and a release position and a drive for pivoting the locking pawl, which drive is coupled in terms of drive via a worm gear to the locking pawl.

The pivoting of the locking pawl controlled via the drive between the locked position and the release position permits an accurate, robust and secure activation and release of the parking brake function.

The worm gear is normally self-locking so that even when the drive of the locking assembly is switched off the output shaft remains securely locked against a release of the vehicle brake. Thus an energizing of the drive can be dispensed with in the locked position, which contributes to an energy-efficient operation of the brake actuator.

In a preferred variant, the drive comprises an electric motor which is coupled to the worm gear. This electric motor is a separate motor from the electric motor which actuates the vehicle brake. It can also be designed to be significantly smaller and less powerful than this motor, since its only task is to move the locking pawl between the locked position and the release position.

It is possible to provide an electronic detection device for detecting the locked position and/or the release position of the locking pawl. One or both end positions of the locking pawl can be identified, for example, via microswitches or a system for monitoring the motor current of the electric motor of the drive of the locking assembly.

In order to be able to act as directly as possible on the output shaft, in the locked position the locking pawl is preferably directly in engagement with a drive pinion which is coupled to the output shaft of the electric motor. Preferably, the drive pinion is positioned on the output shaft of the electric motor and thus has the same axis of rotation as the output shaft.

A relatively small torque acts on the drive pinion due to the small diameter of the pinion, so that the forces acting on the locking assembly, in particular the forces acting on the locking pawl, are also correspondingly small. This permits a cost-effective design of the locking assembly so that the locking assembly does not have to be designed to be as stable as it might have to be with higher torques.

In a preferred embodiment, the locking pawl has at a first end a locking tooth and at a second end a drive part which is rotatable by the drive and which is configured, in particular, as a separate part.

The worm gear preferably comprises a worm wheel which is coupled to a toothing on the drive part and, in particular, is in engagement therewith. The toothing is, for example, a helical toothing which meshes with the worm wheel. The worm wheel is preferably directly arranged on a shaft of the electric motor of the drive, in order to reduce the space requirement of the locking assembly. However, it is also conceivable, for example, to connect a further gearwheel between the shaft and the worm wheel and/or the worm wheel and the drive part, in order to obtain a desired gear ratio.

In order to design the locking pawl in a compact manner, the toothing can be configured only on a portion of the periphery of the drive part. The pivoting movement of the locking pawl between the release position and the locked position in principle is less than 360°. The toothing can thus be limited to the actual pivot angle of the locking pawl. The pivot angle is, for example, between 45° and 180°, in particular approximately 90° to 130°.

Preferably, a hot retensioning (also denoted as a “hot reclamp”) of the electromechanical vehicle brake is possible in order to compensate for a decrease in the tensioning force when the vehicle brake cools down. In order to permit this as part of the parking brake function, the locking tooth can have two differently angled oblique surfaces which are oriented such that, in a first rotational direction of the electric motor increasing the brake force, the locking tooth is pivotable radially outwardly by a toothing on the output shaft into which it engages and, in a second opposing rotational direction releasing the brake force, it blocks the output shaft of the electric motor. In this manner, the locking pawl can be designed to be flexible in the rotational direction of the output shaft increasing the brake force. Thus a retensioning is possible in a simple manner, while an undesired release of the parking brake function and the vehicle brake is nevertheless securely prevented.

The oblique surface of the tooth flank which faces counter to the second rotational direction, relative to the toothing on the output shaft, should be set more steeply than the oblique surface of the tooth flank which faces counter to the first rotational direction. Thus it is ensured that the locking tooth and thus the locking pawl cannot be lifted out of the locked position in the second rotational direction releasing the brake force.

The flexibility in the first rotational direction increasing the brake force can be achieved, for example, by the locking pawl having a pawl arm which terminates in the locking tooth and is connected to the drive part via a spring which is flexible in a rotational direction increasing the brake force and forms a ratchet. This produces a ratchet function by which the locking tooth can respectively jump over a tooth of the toothing on the output shaft when the output shaft is rotated in the direction increasing the brake force. This permits a hot retensioning of the vehicle brake without the locking pawl having to be released by means of the drive.

In particular, in connection with two differently angled oblique surfaces on the locking tooth, a locking pawl can thus be implemented in a simple manner, the locking tooth thereof being pushed radially outwardly by the toothing on the output shaft with a rotation of the output shaft in the first rotational direction, while the locking pawl blocks the toothing with a rotation of the output shaft in the second rotational direction.

The deflection of the locking tooth in the first rotational direction is advantageously brought about exclusively by the toothing on the output shaft and the rotation of the output shaft in the first rotational direction.

The spring can be arranged in any suitable manner in the locking pawl.

In a first possible variant, the locking tooth itself is spring-loaded. For example, the spring is arranged such that the locking tooth can be pushed into the remaining pawl arm counter to the spring action.

In a second possible variant, the spring is arranged in the region of a centre axis of rotation of the drive part and permits a relative rotation of the pawl arm relative to the drive part. The pawl arm can be deflected radially outwardly counter to the action of the spring in order to jump over a tooth of the toothing on the output shaft, so that the locking tooth passes into an adjacent tooth intermediate space of the toothing during the hot retensioning and the rotation of the output shaft of the electric motor associated therewith. Here the pawl arm is pushed radially inwardly by the spring force and thus is again securely locked in a tooth intermediate space at the end of the retensioning movement.

In this variant, the drive part and the pawl arm are accordingly components which are separate from one another and which are coupled to one another via the spring.

The spring should generally be sufficiently stiff that it behaves rigidly during the normal pivoting of the locking pawl into the locked position and into the release position and the locking pawl is moved by the drive as a single component. The pawl arm is deflected relative to the drive part or, in the first variant, the locking tooth is pushed into the pawl arm only when the electromechanical vehicle brake is retightened, in which greater forces act on the locking pawl than during the normal activation and release of the parking brake.

Preferably, the spring is arranged such that it is tensioned by a rotation of the pawl arm relative to the drive part so that, during the deflection, the locking pawl is always pretensioned in the direction of the toothing on the output shaft.

The toothing on the output shaft is produced, for example, on the above-described drive pinion.

In a preferred variant, the locking pawl and, in particular, the pawl arm are rotatably mounted about a centre axis of rotation which is also the centre axis of rotation of the drive part.

For example, the pawl arm is mounted in a recess in the drive part and/or on a pin of the drive part. The spring can be, for example, a leg spring, the windings thereof being placed around the pin, and which with one free end bears against the drive part and with the other free end bears against the pawl arm. During the relative rotation of the pawl arm and drive part, the free end on the pawl arm is thus entrained by the pawl arm and tensions the spring.

Preferably, cooperating stops, which define a rotation of the pawl arm relative to the drive part but permit a radial deflection of the pawl arm relative to the drive part, are configured in the drive part and in the pawl arm. For example, the pawl arm and the drive part have axially protruding stop cams acting therebetween in the rotational direction.

The electric motor of the electromechanical vehicle brake, as is known, is preferably coupled in terms of drive via a gear unit and a spindle drive to an actuating carriage which can be selectively moved between a retracted position and an extended position in order to apply a brake pad to a brake rotor. Thus a rotation of the output shaft of the electric motor can be transferred into a linear movement of the actuating carriage, whereby an axial feed force is produced in order to apply the brake pad to the brake rotor.

If such an electromechanical vehicle brake is used as a service brake in order to decelerate a vehicle during normal vehicle operation, the drive of the locking assembly is not actuated. Only when the vehicle brake is to be used as a parking brake is the output shaft locked in the closed position by the locking assembly after the brake pad is applied to the brake rotor, by the locking pawl being pivoted into the locked position. For releasing the parking brake, the locking pawl is pivoted back again by the drive out of the locked position into the release position.

The above-mentioned object is also achieved by a method for operating a brake actuator of an electromechanical vehicle brake as has been described above. The method has the following steps:
activating the electromechanical vehicle brake,
operating the drive and pivoting the locking pawl into the locked position, wherein the locking pawl engages in a tooth intermediate space of a drive pinion which is coupled to the output shaft of the electric motor,
holding the locking pawl in the locked position, and
retightening the electromechanical vehicle brake when the brake cools down, wherein the drive pinion rotates in a direction increasing the brake force and the locking pawl is released from the tooth intermediate space counter to a spring force and after the rotation of the drive pinion is latched by the spring force in an adjacent tooth intermediate space.

In the opposing rotational direction the drive pinion is blocked by the locking pawl, in principle for a sufficient length of time until the drive of the locking assembly is actuated and the locking pawl is pivoted into the release position.

### BRIEF DESCRIPTION OF THE DRAWINGS

The invention is described hereinafter in more detail by way of several exemplary embodiments with reference to the accompanying figures. In the figures:

FIGS. 1 and 2 show a vehicle brake with a brake actuator according to the invention in a schematic perspective view and in a sectional view;

FIG. 3 shows a schematic perspective overall view of a locking assembly of a brake actuator according to the invention;

FIG. 4 shows a plan view of the locking assembly of FIG. 3;

FIG. 5 shows a detailed view of the locking assembly of FIG. 3 according to a first variant;

FIGS. 6 and 7 show the locking assembly of FIG. 3 according to a further variant; and

FIGS. 8 to 12 show detailed views of the locking assembly of FIG. 6.

### DESCRIPTION

For reasons of clarity, not all of the identical parts are always provided with reference signs. The same reference signs in different embodiments denote identical or substantially identical or similar-acting parts and components.

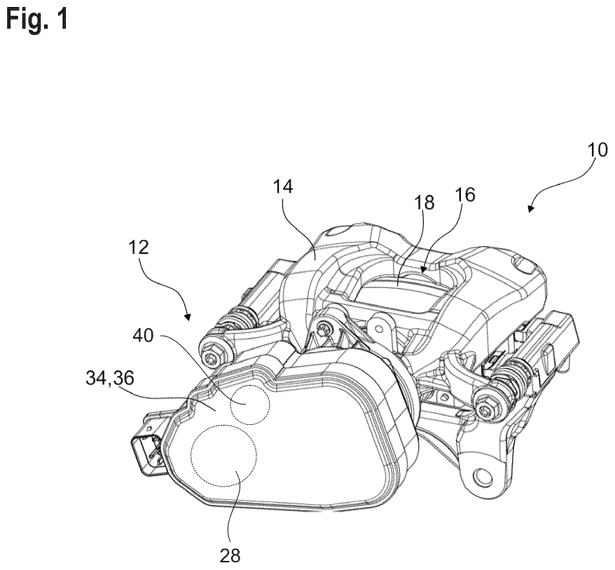

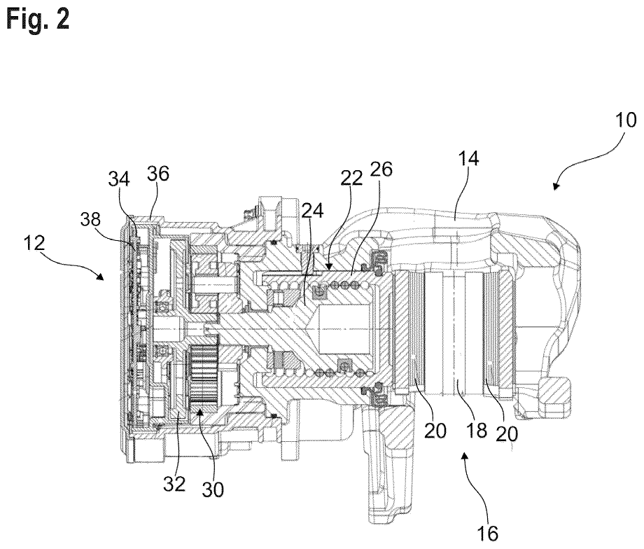

FIGS. 1 and 2 show an electromechanical vehicle brake 10 with a brake actuator 12 in a perspective view and in a sectional view.

In this example, the vehicle brake 10 is used as a service brake of a vehicle. This means that the vehicle brake 10 serves for braking the vehicle in normal driving mode. In addition, the vehicle brake 10 has a parking brake function which thus also serves for locking the parked vehicle in position.

The brake actuator 12 comprises a brake calliper 14 in which an intermediate space 16 is formed for a brake rotor 18. A brake pad 20 (see FIG. 2) which can be applied to the brake rotor 18 is arranged in the intermediate space 16.

The brake actuator 12 also comprises a spindle drive 22 which in the exemplary embodiment is a ball screw drive with a rotatably mounted spindle 24 which is driven by motor and on which an actuating carriage 26 is mounted. The spindle 24 serves for axially moving the actuating carriage 26. The actuating carriage 26 forms the spindle nut of the spindle drive 22. In practice, the actuating carriage 26 represents a brake piston. The actuating carriage 26 is selectively movable by axial displacement between an extended and a retracted position in order to apply the brake pad 20 to the brake rotor 18. In the extended position, the actuating carriage 26 pushes against the brake pad 20 and transfers an axial feed force to the brake pad 20.

The brake actuator 12 also comprises an electric motor 28 (indicated in FIG. 1) for actuating the vehicle brake 10.

In addition, the brake actuator 12 comprises a gear unit 30.

The electric motor 28 is coupled in terms of drive via the gear unit 30 and the spindle drive 22 to the actuating carriage 26, in order to move the actuating carriage 26 between the retracted position and the extended position.

The gear unit 30 is mounted on a frame part 32 of the brake actuator 12. The frame part 32 absorbs all of the reaction forces and reaction torques which occur when actuating the vehicle brake 10 and diverts them into the brake calliper 14.

For activating the electric motor 28, the brake actuator 12 comprises an electronics unit 34 which is accommodated in an electronics housing 36. The electronics unit 34 in the exemplary embodiment is a printed circuit board 38 as can be seen in FIG. 2. The electronic parts required for activating the electric motor 28 are arranged on the printed circuit board 38.

Since the vehicle brake 10 is configured as a service brake it is self-releasing. This means that, as soon as the electric motor 28 is not active in normal driving mode, the actuating carriage 26 can move and be released from the brake pad 20.

In order to implement the additional parking brake function, the brake actuator 12 has a locking assembly 40 for selectively rotationally blocking an output shaft 42 of the electric motor 28.

The locking assembly 40 comprises a locking pawl 44 which is pivotable by means of a drive 46, in this case a further electric motor, between a release position and a locked position.

The electric motor of the drive 46 is separate from the electric motor 28 which actuates the vehicle brake 10 and is designed to be significantly smaller and less powerful. For example, it is a miniature DC electric motor.

Optionally a motor current of the electric motor of the drive 46 is monitored in order to detect the end positions of the locking pawl 44. To this end, alternatively or additionally microswitches are optionally provided.

The electric motor of the drive 46 is electronically connected, for example, via press-in plug contacts to the electronics unit 34, in particular to the conductor tracks of the printed circuit board 38.

The locking pawl 44 engages with a locking tooth 48 at its first end into a toothing 50, which in this case is directly located on the output shaft 42 of the electric motor 28 of the vehicle brake 10. The toothing 50 in this example is configured on a drive pinion 52 which is located directly on the output shaft 42.

The drive pinion 52 also meshes (not shown) with a planetary gear set of the gear unit 30 of the brake actuator 12 and transfers the drive force to the spindle drive 22 for actuating the vehicle brake 10.

For activating the parking brake function, the locking pawl 44 is pivoted by the drive 46 into engagement with the toothing 50 into a locked position. In order to release the parking brake function, the locking pawl 44 is pivoted again by the drive 46 out of engagement with the toothing 50 into a release position.

The movement of the locking pawl 44 is carried out by a worm gear 54, which is driven by the drive 46. The worm gear 54 comprises a worm wheel 56 which in this example is arranged directly on a shaft 58 of the electric motor of the drive 46. The worm wheel 56 meshes in this case with a toothing 60 on a drive part 62 of the locking pawl 44. The toothing 60 is configured as a helical toothing. The drive part 62 is arranged on a second end of the locking pawl 44 opposing the locking tooth 48, and is connected to the locking tooth 48 via a pawl arm 64.

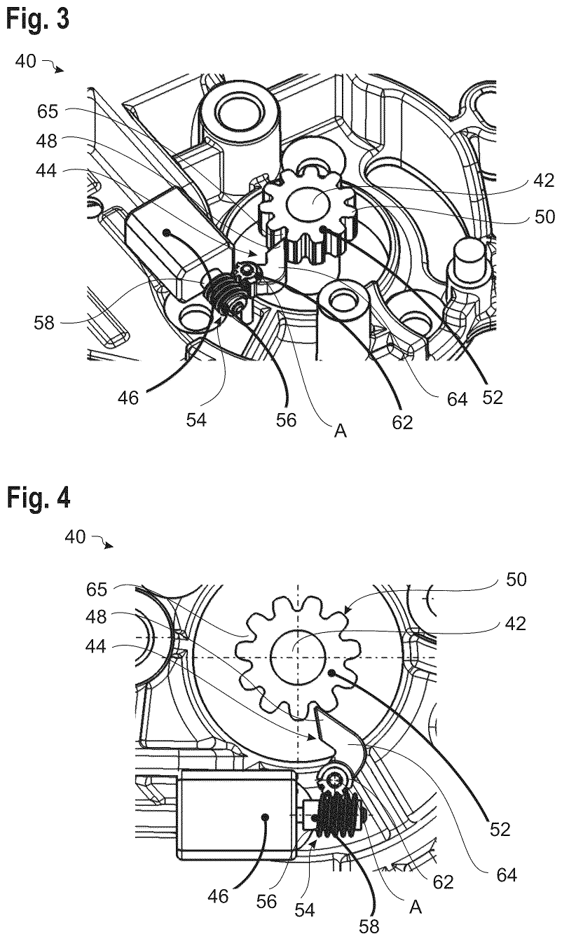

The toothing 60 is configured only on a portion of the periphery U of the drive part 62 which corresponds to the actual pivot angle α of the locking pawl 44 (see for example FIGS. 3 and 6). The pivot angle is, for example, between 45° and 180°, in particular approximately 90° to 130°. The pivot axis of the locking pawl 44 coincides in this case with a centre axis of rotation A of the drive part 62 and the pawl arm 64.

For activating the parking brake function, the locking pawl 44 is pivoted by the drive 46 into its locked position. To this end, the electric motor of the drive 46 is actuated so that the worm wheel 56 is rotated and rotates the drive part 62.

The locking pawl 44 is pivoted radially inwardly to a sufficient extent that the locking tooth 48 engages in a tooth intermediate space 65 between two adjacent teeth of the toothing 50 and thus blocks the output shaft 42. Due to the self-locking of the worm gear 54, the motor of the drive 46 can now be switched off and the output shaft 42 remains blocked.

For releasing the parking brake function, and the release of the vehicle brake 10 associated therewith, the locking pawl 44 is pivoted by the drive 46 back into the release position. To this end, the electric motor of the drive 46 rotates in the opposing direction and the worm wheel 56 rotates the drive part 62 in the opposing direction. Accordingly, the locking tooth 48 is radially outwardly moved out of engagement with the toothing 50.

In the examples shown here, the locking assembly 40 is configured such that, when the parking brake function is activated, a hot retensioning of the vehicle brake 10 is possible without actuating the drive 46.

To this end, the locking pawl 44 comprises a spring 66 which produces a radial flexibility of a portion of the pawl arm 64 or the entire pawl arm 64. Thus a ratchet function of the locking assembly 40 is implemented, in which the locking pawl 44 functions as a ratchet.

The locking tooth 48 is configured such that it has two differently angled oblique surfaces 68, 70 on opposing tooth flanks. The oblique surface 68 is configured to be flatter relative to the toothing 50 than the oblique surface 70. Accordingly, the oblique surface 68 is oriented such that it faces counter to a first rotational direction R which corresponds to a rotational direction of the electric motor 28 increasing the brake force, and thus of the output shaft 42 and of the drive pinion 52. Thus in this rotational direction R the locking tooth 48 can be deflected radially outwardly by the toothing 50. In the opposing second rotational direction of the output shaft 42 releasing the brake force, however, the toothing 50 blocks the oblique surface 70 of the locking tooth 48. Thus a deflection of the locking tooth 48 is prevented and a rotation of the output shaft 42 is blocked and the vehicle brake 10 remains closed.

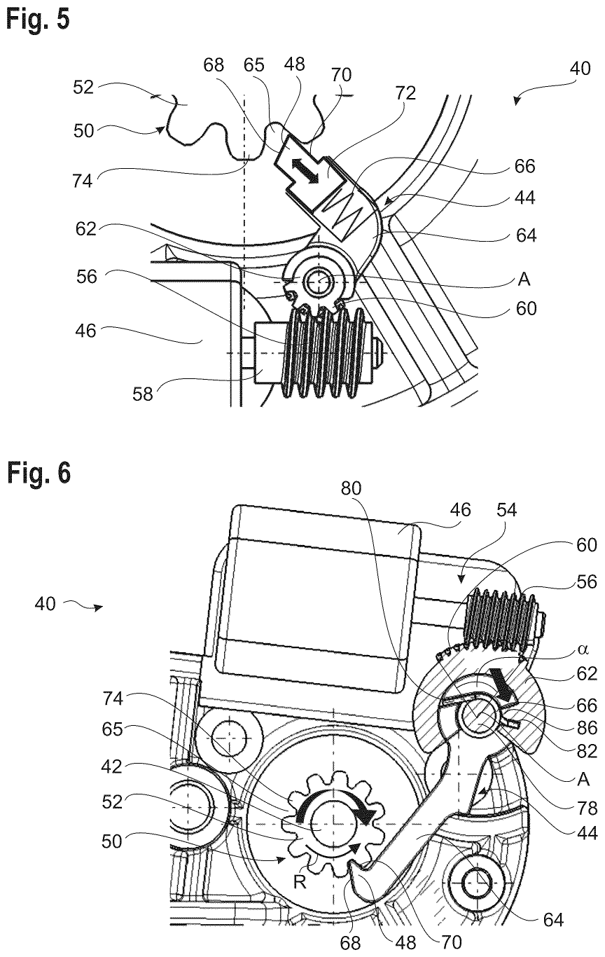

In a first variant, shown in FIG. 5, a portion 72 of the pawl arm 64 directly adjoining the locking tooth 48 is displaceable in a linear manner counter to the spring 66 inserted in the remaining pawl arm 64 so that the locking tooth 48 is pushed into the pawl arm 64 and thus the pawl arm 64 as a whole can be shortened. The spring 66 in this example is a helical spring which is axially compressed and thereby tensioned with the deflection movement.

During the hot retensioning of the vehicle brake 10, the electric motor 28 moves the output shaft 42 and thus the drive pinion 52 in the first rotational direction R, increasing the brake force.

The locking pawl 44 remains in principle pivoted into the locked position, i.e. the drive part 62 remains in the angular position into which it has been moved by the drive 46 when activating the parking brake function.

A tooth flank of a tooth of the toothing 50 acts on the oblique surface 68 of the locking tooth 48. The locking tooth 48 is thereby pushed into the pawl arm 64 counter to the spring force and the output shaft 42 can be rotated further in the direction R. When the tooth tip 74 of the tooth has passed the locking tooth 48, the spring 66 pushes the locking tooth 48 into the adjacent tooth intermediate space 65 in which the locking tooth 48 is latched again. In this manner, the vehicle brake 10 can be retightened without actuating the drive 46 of the locking assembly 40.

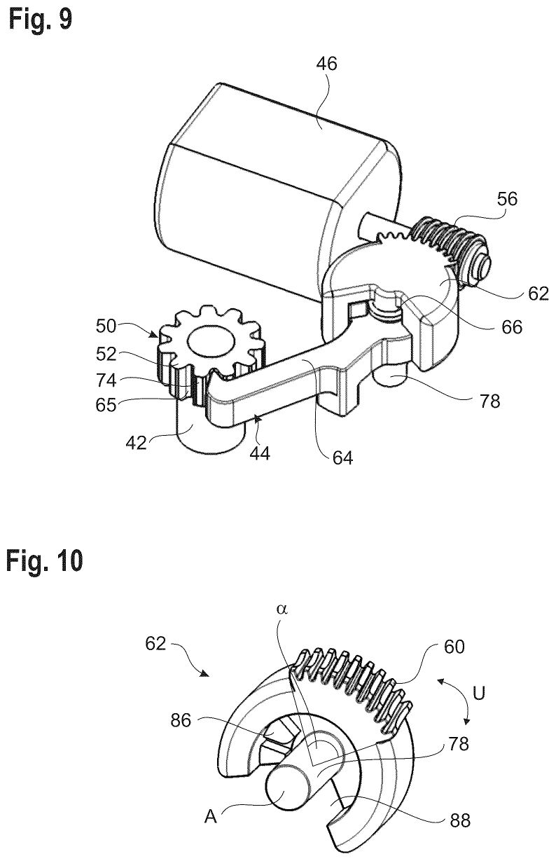

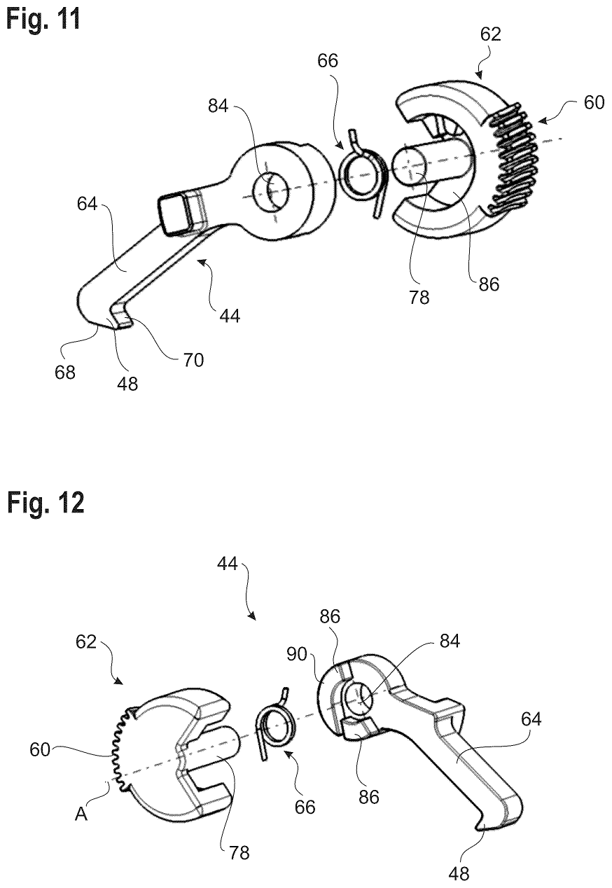

A further variant of the locking assembly 40 is shown in FIGS. 6 to 12.

In contrast to the first variant, shown in FIG. 5, in this case the locking tooth 48 is designed integrally with the pawl arm 64 and the spring 66 is arranged between the pawl arm 64 and the drive part 62. The pawl arm 64 can be deflected radially counter to the force of the spring 66 relative to the drive part 62, wherein the spring 66 is tensioned.

The spring 66 in this case is a leg spring, the windings thereof being placed about a pin 78 of the drive part 62 oriented along the centre axes of rotation A, and the free ends 80, 82 thereof being secured to the drive part 62 and to the pawl arm 64.

The pin 78 engages in a recess 84 on the end of the pawl arm 64 opposing the locking tooth 48 and thus couples the pawl arm 64 to the drive part 62. In this example, the locking pawl 44 is also mounted on the housing of the brake actuator 12 via the pin 78.

In this variant, the drive part 62 and the pawl arm 64 are two components which are separate from one another and which are connected together only via the spring 66 and in this case also the pin 78.

The pawl arm 64 can be rotated about the centre axis of rotation A in a certain angular range relative to the drive part 62 when a force acts in the first rotational direction R on the locking tooth 48. The rotational movement is defined by suitably configured axially protruding stop cams 86 on the pawl arm 64 and on the drive part 62 which come into contact with one another at the end of the desired rotational angle α.

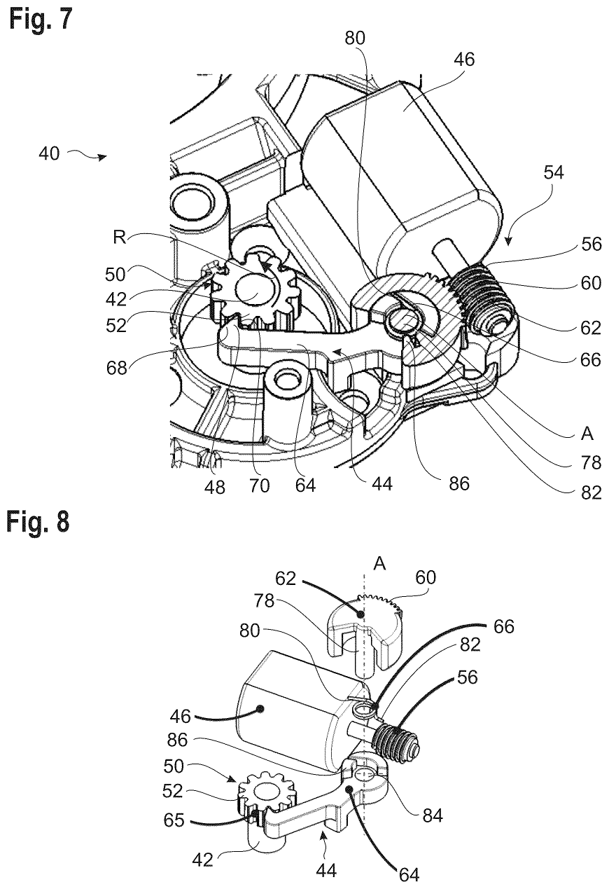

In this example, the stop cams 86 on the drive part 62 and on the pawl arm 64 have in each case a slot for receiving one of the free ends 80, 82 of the spring 66 in order to secure the spring 66 both to the drive part 62 and to the pawl arm 64 (see for example FIG. 7).

The pin 78 is surrounded by a recess 88 in the drive part 62 into which a wall portion 90 of the pawl arm 64 engages. The wall portion 90 in this case is part of one of the stop cams 86 and partially surrounds the recess 84 for the pin 78.

As described above, during the hot retensioning, the output shaft 42 is rotated in the direction R increasing the brake force, and thus the locking tooth 48 is deflected radially outwardly due to the action on its flatter oblique surface 68 of a tooth of the toothing 50 on the output shaft 42. Due to this action of force, the pawl arm 64 moves counter to the force of the spring 66 and increases the spring tension thereof.

Once the tooth tip 74 has passed the locking tooth 48, the spring 66 pushes the locking tooth 48 into the adjacent tooth intermediate space 65 due to the spring tension, and the output shaft 42 is once again blocked against a rotation in the rotational direction releasing the brake force.

The pawl arm 64 is deflected relative to the drive part 62 only during the hot retensioning of the vehicle brake 10. If the locking pawl 44 is pivoted by the drive 46, the behaviour of the spring 66 is sufficiently rigid that the pawl arm 64 and the drive part 62 are moved together.

1. Brake actuator (12) for an electromechanical vehicle brake (10), having an electric motor (28) for actuating the vehicle brake (10) and a locking assembly (40) for selectively rotationally blocking an output shaft (42) of the electric motor (28) to form a parking brake function, wherein the locking assembly (40) comprises a locking pawl (44) which is pivotable between a locked position and a release position and a drive (46) for pivoting the locking pawl (44), which drive is coupled in terms of drive via a worm gear (54) to the locking pawl (44).

2. Brake actuator (12) according to claim 1, wherein in the locked position the locking pawl (44) is directly in engagement with a drive pinion (52) which is coupled to the output shaft (42) of the electric motor (28).

3. Brake actuator (12) according to claim 1, wherein the locking pawl (44) has at a first end a locking tooth (48) and at a second end a drive part (62) which is rotatable by the drive (46) and which is configured, in particular, as a separate part.

4. Brake actuator (12) according to claim 3, wherein the worm gear (54) comprises a worm wheel (56) which meshes with a toothing (60) on the drive part (62).

5. Brake actuator (12) according to claim 4, wherein the toothing (60) is configured only on a portion of the periphery (U) of the drive part (62).

6. Brake actuator (12) according to claim 3, wherein the locking tooth (48) has two differently angled oblique surfaces (68, 70) which are oriented such that, in a first rotational direction (R) of the electric motor (28) increasing a brake force, the locking tooth (48) is pivotable radially outwardly by a toothing (50) on the output shaft (42) into which it engages, and in a second opposing rotational direction releasing the brake force it blocks the output shaft (42) of the electric motor (28).

7. Brake actuator (12) according to claim 3, wherein the locking pawl (44) has a pawl arm (64) which terminates in the locking tooth (48) and is connected to the drive part (62) via a spring (66) and forms a ratchet, wherein the spring (66) is flexible in a rotational direction (R) of the drive part (62) in which the brake force is increased.

8. Brake actuator (12) according to claim 7, wherein the spring (66) is arranged such that it is tensioned by a rotation of the pawl arm (64) relative to the drive part (62).

9. Brake actuator (12) according to claim 3, wherein the pawl arm (64) is rotatably mounted about a centre axis of rotation (A) which is also the centre axis of rotation (A) of the drive part (62).

10. Brake actuator (12) according to claim 9, wherein the pawl arm (64) is mounted in a recess (88) in the drive part (62) and/or on a pin (78) of the drive part (62).

11. Brake actuator (12) according to claim 8, wherein the pawl arm (64) and the drive part (62) have axially protruding stop cams (86) acting therebetween in the rotational direction.

12. Brake actuator (12) according to claim 1, wherein the electric motor (28) is coupled in terms of drive via a gear unit (30) and a spindle drive (22) to an actuating carriage (26) which can be selectively moved between a retracted position and an extended position in order to apply the brake pad (20) to a brake rotor (18).

13. Method for operating a brake actuator (12) of an electromechanical vehicle brake (10) according to claim 1, having the steps:
activating the electromechanical vehicle brake (10),
operating the drive (46) and pivoting the locking pawl (44) into the locked position, wherein the locking pawl (44) engages in a tooth intermediate space (65) of a drive pinion (52) which is coupled to the output shaft (42) of the electric motor (28),
holding the locking pawl (44) in the locked position, and
retightening the electromechanical vehicle brake (10) when the vehicle brake (10) cools down, wherein the drive pinion (52) rotates in a direction (R) increasing the brake force and the locking pawl (44) is released from the tooth intermediate space (65) counter to a spring force and after the rotation of the drive pinion (52) is latched by the spring force in an adjacent tooth intermediate space (65).
